(19) United States
(12) Patent Application Publication
(10) Pub. No.: US 2007/0059461 A1
(43) Pub. Date: Mar. 15, 2007

(54) Chip dipper

(76) Inventor: Jay B. Carr, Montpelier, VT (US)

Correspondence Address: JAMES RAY & ASSOCIATES, 2640 Pitcairn Road, Monroeville, PA, 15146, US

(21) Appl. No.: 11/517,998

(22) Filed: Sep. 7, 2006

Related U.S. Application Data
(60) Provisional application No. 60/716,108, filed on Sep. 12, 2005.

(51) Int. Cl. B31B 45/00

(52) U.S. Cl. 428/34.1; 428/34.4; 428/35.7

(57) ABSTRACT

A container having each of a predetermined shape and a predetermined size and made of a predetermined material for containing a preselected dip. The container has a lip means disposed on an upper portion of the container for removing excess preselected dip from at least one of a chip, cracker, pretzel and vegetable used for dipping in said preselected dip.

### CROSS REFERENCE TO RELATED APPLICATIONS

This application is closely related to and claims benefit from U.S. Provisional Application Ser. No. 60/716,108 filed Sep. 12, 2005.

### FIELD OF THE INVENTION

The present invention relates, in general, to a chip dipper, and, more particularly, the present invention relates to a chip dipper which will essentially eliminate the mess that is usually found around a chip dipper.

### BACKGROUND OF THE INVENTION

At parties, at home or even at work consumers enjoy snacking. One of the favorite snacking items for many consumers is chips and dips. Dips, whether the dip is chunky or creamy, can be very messy when eaten from conventional bowls, trays and plates. Dips often slides, drops and runs off the side of the chip, cracker or vegetable. This can leave a messy area around the dip area, not to mention the stains on clothing. This can be particularly a problem where the dip is a salsa dip but it is even a problem where the dip is a vegetable dip or a cracker dip.

Thus, it would be advantageous if there were a way to allow individuals to easily enjoy dipping their food into dips without making a mess of the area or their clothing.

### SUMMARY OF THE INVENTION

According to an embodiment of the invention the present invention provides a container having each of a predetermined shape and a predetermined size and made of a predetermined material for containing a preselected dip. The container has a lip means disposed on an upper portion of the container for removing excess preselected dip from at least one of a chip, cracker, pretzel and vegetable used for dipping in said preselected dip.

### OBJECTS OF THE INVENTION

It is, therefore, one of the primary objects of the present invention is to provide a chip dipper that can be used without making a mess.

Another object of the present invention is to provide a chip dipper that has a lip for removing excess dip.

Still another object of the present invention is to provide a chip dipper wherein the shape of the chip dipper is a wave shaped container.

Yet another object of the present invention is to provide a chip dipper which has a circular shape.

Another object of the present invention is to provide a chip dipper that can be used with a wide variety of dips be they chunky or creamy.

These and various other objects and advantages of this invention will become apparent after a full reading of the following detailed description, particularly, when read in conjunction with the attached drawings as described below and the appended claims.

### BRIEF DESCRIPTION OF THE DRAWINGS

FIG. 1 is a perspective view of the container showing a rectangular version with elliptical ends according to an embodiment of the invention.

FIG. 2 is a top view of a round container for holding a preselected dip according to an alternate embodiment of the invention.

FIG. 3 is a cross-sectional view of the container shown in FIG. 2 taken across the lines III-III.

### BRIEF DESCRIPTION OF THE PRESENTLY PREFERRED AND ALTERNATE EMBODIMENTS OF THE INVENTION

Prior to proceeding with the more detailed description of the present invention it should be noted that, for the sake of clarity, identical components which have identical functions have been designated by identical reference numerals throughout the several views illustrated in the drawings.

According to an embodiment of the invention the present invention provides a container, generally designated 10, having each of a predetermined shape and a predetermined size and made of a predetermined material for containing a preselected dip 12. The container 10 has a lip means 2 disposed on an upper portion of the container 10 for removing excess preselected dip from at least one of a chip, cracker, pretzel and vegetable used for dipping in the preselected dip 12.

The container 10 can have a variety of shapes, among these are substantially rectangular, circular and oval. The shape could also be octagonal or hexagonal; however, they are basically just variations of the circular shape.

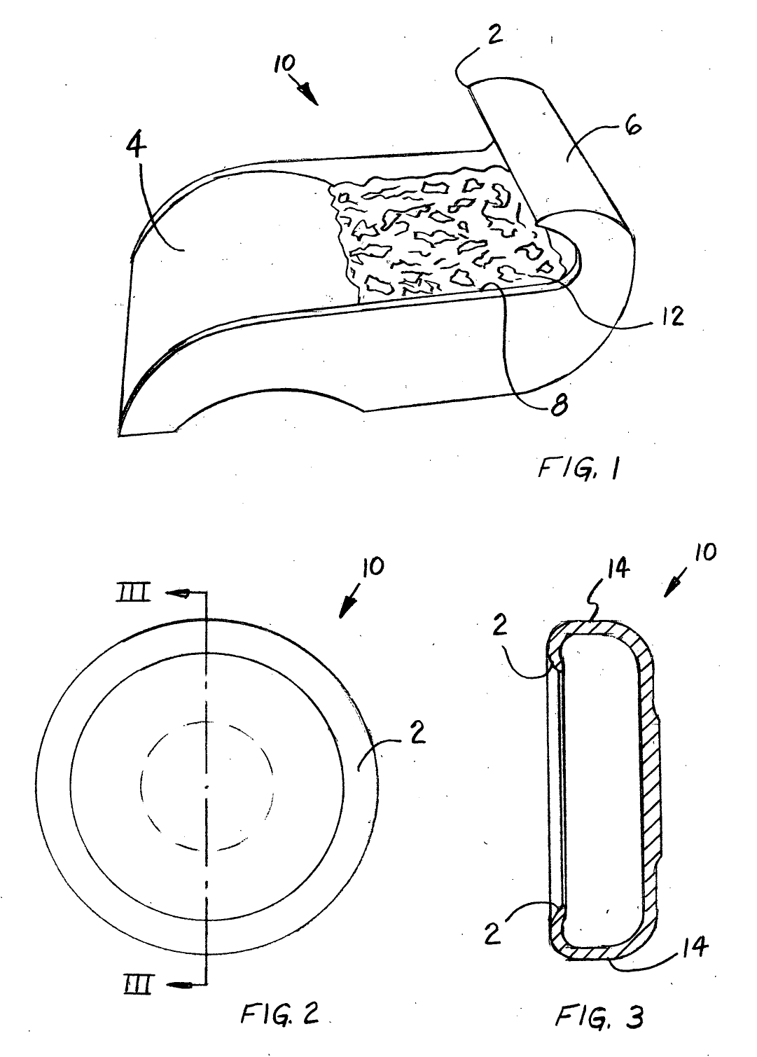

As can be seen in FIG. 1 the container 10 in one aspect of the invention has a unique shape. The shape of the container is substantially rectangular in that the sides are parallel; however the shape is also substantially ellipsoidal wherein the front section 4 is substantially elliptical and a back section 6 is also elliptical forming a wave shape which makes it easy to dip into the preselected dip. The container 10 has an open portion 8 between the front section 4 and the back section 6 for containing the preselected dip.

The lip member 2 of container 10 is disposed on an end of the back section 6 that overhangs the open portion 8 of the container 10 containing the preselected dip 12.

As stated previously the wave shape of the container 10 helps to scoop dip onto such at least one of a chip, cracker, pretzel and vegetable used for dipping in the preselected dip 12.

The lip means 2 helps to prevent spills by removing excess dip on such chip, cracker, pretzel or vegetable that is being used for dipping into the preselected dip 12.

The predetermined material for such container 10 is selected from one of plastic, glass ceramic, porcelain and metal. It is presently preferred that such material is plastic.

As mentioned previously such container 10 can also be substantially circular. In this case the lip means 2 is disposed on an upper periphery of the wall 14 of the substantially circular container 10 wherein the lip means 2 overhangs the open portion 16 of the substantially circular container 10 that contains such preselected dip 12.

Generally the lip means 2 helps to prevent spills by removing excess dip on the chip, cracker, pretzel or vegetable that is being used for dipping in the preselected dip 12. Such dip can be any variety and can be creamy or chunky. The dip could be salsa or a French onion dip or any other variety of dip that one would dip crackers, chips (be they nacho, tortilla, or potato), pretzels or vegetables.

The preselected material used for making the container 10 could be white or any of the colors of the rainbow and also could be decorated with designs or logos. It is presently preferred that such container be colored but with no preference as to the color.

While a presently preferred embodiment and alternate embodiments of the present invention has been described in detail above, it should be understood that various other adaptations and/or modifications of the invention can be made by those persons who are particularly skilled in the art without departing from either the spirit of the invention or the scope of the appended claims.

I claim:

1. A container having each of a predetermined shape and a predetermined size and made of a predetermined material for containing a preselected dip, said container having a lip means disposed on an upper portion of said container for removing excess preselected dip from at least one of a chip, cracker, pretzel and vegetable used for dipping in said preselected dip.

2. The container, according to claim 1, wherein said predetermined shape of said container is one of rectangular, oval and circular.

3. The container, according to claim 2, wherein said predetermined shape is substantially rectangular.

4. The container, according to claim 3, wherein said substantially rectangular shape further is substantially ellipsoidal wherein a front section of said container is elliptical and a back section of said container is elliptical forming a wave shape and wherein sides of said container are substantially parallel.

5. The container, according to claim 4, wherein said container has an open portion disposed between said front section and said back section for containing said preselected dip.

6. The container, according to claim 5, wherein said lip means is disposed on an end of said back section which overhangs said open portion of said container containing said preselected dip.

7. The container, according to claim 6, wherein said wave shape of said container helps to scoop dip onto such at least one of a chip, cracker, pretzel and vegetable used for dipping in said preselected dip.

8. The container, according to claim 7, wherein said lip means helps to prevent spills by removing excess dip on said at least one of a chip, cracker, pretzel and vegetable used for dipping in said preselected dip.

9. The container, according to claim 1, wherein said predetermined material for said container is one of plastic, glass ceramic, porcelain and metal.

10. The container, according to claim 9, wherein said container is plastic.

11. The container, according to claim 2, wherein said container is substantially circular.

12. The container, according to claim 9, wherein said lip means is disposed on an upper periphery of said substantially circular container wherein said lip means overhangs an open portion of said substantially circular container containing such preselected dip.

13. The container, according to claim 12, wherein said lip means helps to prevent spills by removing excess dip on said at least one of a chip, cracker, pretzel and vegetable used for dipping in said preselected dip.

14. The container, according to claim 1, wherein said preselected dip is one of creamy and chunky.

15. The container, according to claim 9, wherein said preselected material is colored.
